(19) United States
(12) Patent Application Publication
(10) Pub. No.: US 2007/0205253 A1
(43) Pub. Date: Sep. 6, 2007

(54) Method for diffusion soldering

(75) Inventor: Holger Hubner, Baldham (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Munich (DE)

(21) Appl. No.: 11/370,205

(22) Filed: Mar. 6, 2006

(51) Int. Cl. B23K 20/00

(52) U.S. Cl. 228/193

(57) ABSTRACT

A method for connecting at least two metal layers by means of a diffusion soldering process, wherein each of the metal layers that is to be connected is plated with a respective solder layer prior to the diffusion soldering process.

### TECHNICAL FIELD

The present invention relates to a method for connecting metal layers by means of a diffusion soldering process.

### BACKGROUND

Diffusion soldering, also known as solid-liquid interdiffusion bonding, is a lead-free interconnection technology based on the principle of isothermal solidification. A low melting solder layer placed between two high melting metal layers or substrates is heated and reacts rapidly to form inter-metallic compounds which have a melting point that is higher than that of the low melting solder.

FIG. 1 illustrates the connection of two metal layers by means of a conventional diffusion soldering process. A top chip 10 is arranged with its active main area on top of a bottom wafer 1. Alternatively, a plurality of top chips 10 can be arranged on the bottom wafer 1 or on a substrate. A patterned metal layer 2 is arranged on the bottom wafer 1 and another, usually symmetrically patterned metal layer 11 is arranged on the top chip 10. The metal layers 2 and 11 are made from copper and have thicknesses of 1 to 5 μm. A thin solder layer 12 is applied to the metal layer 11 of the top chip 10. The solder layer 12 is usually made of tin or a tin-silver alloy and has a thickness between 0.5 to 3 μm. The total thickness of the metal layers 2 and 11 and the solder layer 12 is typically less than 10 μm. In comparison with other connection methods, such as bonding wires, conductive adhesives or solder balls the metal layers 2 and 11 can be patterned in the range of 1 μm on account of their small thickness. The fine patterning allows diffusion soldering to be used for interconnecting chips with very high interconnection densities.

In order to produce an electrical connection, the top chip 10 is placed on the bottom wafer 1 by a placing tool and is fixed in place by means of an adhesive. The bottom wafer 1 is then placed in the soldering oven and heated until the solder of the solder layer 12 melts. During soldering the top chip 10 is pressed onto the bottom wafer 1 by means of a temperature resistant mat 20. A pressure of about 3 bar is required so that the molten solder sufficiently wets the metal layer 2 of the bottom wafer 1. The pressure one the temperature resistant mat 20 also prevents cavities from being formed in the molten solder.

The pressure on the temperature resistant mat 20 fixes the top chip 10 in place so that it cannot self-align itself by means of the surface tension in the molten solder during the soldering process. As self-alignment is not possible, placing tools with higher positioning accuracy have to be used. However, high-precision placing tools are not only expensive but also slow, so that the manufacturing throughput is decreased. Even with accurate positioning available the temperature resistant mat 20 may cause a lateral displacement of the top chip 10 due to its thermal expansion during the soldering process. If the lateral displacement between the top chip 10 and the bottom wafer 1 is large, the solder reacts with only part of the opposite metal layer 2. In this case, the sidewalls of the metal layer 2 can be alloyed so deeply that diffusion barriers which separate the copper layer 2 from the aluminum pads underneath are damaged and corrosion problems at the copper-aluminum interfaces are likely to occur.

Another disadvantage of applying pressure to the bottom wafer 1 and the top chip 10 is that the pressure on the molten solder 12 causes the evaporation rate of the solder 12 to increase, so that a thin solder layer is deposited in the gaps between the metal layer patterns. The resistance of this deposited solder layer is typically between 1 to 10 kΩ and leads to leakage currents in the range of several mA. In contrast, leakage currents in diffusion soldering processes without external pressure are only in the range of pA.

Still another disadvantage of using the temperature resistant mat 20 to press the top chip 10 onto the bottom wafer 1 is that the pressure in the solder 12 depends on the thickness of the top chip 10. If several top chips 10 are to be soldered in the same step, thick top chips 10 will have some of their solders squashed out due to the higher pressure while thin top chips 10 are likely to suffer from poor connections due to insufficient wetting and cavities. The pressure in the solder 12 also depends on the ratio of the area of the patterns of the metal layer 11 to the area of the top chip so that the same holds true for top chips 10 with different area ratios of metallization to chip area.

A possible solution to the above problems is to do away with the temperature resistant mat 20 and to use an individual spring for each of the top chips 10. The spring would allow at least some lateral movement of the top chip 10 and therefore some self-alignment during the soldering process. However, providing an individual spring for each top chip and adjusting the springs to different heights and varying ratios of patterns of the metal layers to chip area is intricate and expensive. Also due to the pressure, the evaporation rate of the solder is still increased causing leakage through the deposited solder layer.

Because of the above mentioned disadvantages, it would be preferable to use diffusion soldering without having to apply an external pressure. Experiments have shown that the formation of cavities depends on the volume of solder. For large diffusion soldering joints, the reaction of the molten solder to form intermetallic compounds causes a reduction in volume and without external pressure, the molten solder will not be pressed into the resultant cavities. In contrast, small diffusion solder joints can be formed without applying external pressure and still have only negligibly small cavities. In principle it would therefore be possible to use a diffusion soldering method for small soldering joints without applying external pressure.

However, a self-aligning of the top chip 10 would still not occur because of the small volumes of solder being used in the diffusion soldering process. For large volumes of solder, such as for surface-mounted devices (SMD) or flip-chip assembly, where solder balls with diameter of 60 to 100 μm are used, the solidification of the solder occurs only after the cooling of the joint. The solder can be held in a molten state until the top chip 10 has moved into the desired position. However, for diffusion soldering, solidification occurs at the soldering temperature when all of the solder has reacted to form inter-metallic compounds. Because of the small volume of solder involved, solidification only takes a few tenths of a second. While this could mean that the top chip 10 does not have enough time to mechanically self-align itself, the limited time also causes another problem. The molten solder 12 must wet the metal layer 2 of the bottom wafer 1 before it can react with it to form intermetallic compounds. The wetting process is always kinetically inhibited, for example, by the presence of oxides, so that the molten solder wets the metal layer not instantly but only with a certain velocity. In the case of the larger solder volumes used in surface-mounted devices or flip-chip assembly, the time until solidification by cooling is long enough for a complete wetting of the metal layers to occur. In contrast, diffusion soldering joints without pressure solidify before the metal layers are completely wetted. As a result, the borders of the molten solder are irregular so that no self-alignment due to surface tension takes place. In principle, self-alignment could be achieved by increasing the volume of solder. However, in that case the special properties of fully alloyed contacts in diffusion soldering joints such as the high melting point or the high electron migration resistivity would be lost.

### SUMMARY

It is accordingly an object of the invention to provide a method for connecting at least two metal layers by means of a diffusion soldering process, in which no external force has to be applied to the metal layers and in which the metal layers are self-aligning. At the same time, the metal layers should be wetted well by the molten solder and the molten solder should be sufficiently free of cavities.

Accordingly, the present invention provides in one aspect a method for connecting at least two metal layers by means of a diffusion soldering process, wherein each of the metal layers that is to be connected is plated with a respective solder layer prior to the diffusion soldering process. Since both metal layers are plated with a solder layer, the molten solder does not need to wet the metal layers. The metal layers are already covered with solder so that the wetting is not inhibited by any oxides present.

Specifically, the metal layers are self-aligned with respect to each other during the diffusion soldering process by means of forces due to the surface tension in the molten solder joining the metal layers. The self-alignment is caused by forces, which try to move the metals layers into such a position with respect to each other that the surface area of the molten solder is minimized. This allows the use of placing tools with lower precision and higher throughput.

The invention also provides a mechanical connection for connecting at least two metal layers by means of a diffusion soldering process, wherein each of the metal layers that is to be connected is plated with a respective solder layer.

Further aspects and features of the present invention can be appreciated from the appended Figures and the accompanying written description.

### BRIEF DESCRIPTION OF THE DRAWING FIGURES

The invention will now be described in more detail with reference to the accompanying drawings in which:

FIG. 1 illustrates the connection of two metal layers by means of a conventional diffusion soldering process;

FIG. 2 illustrates the connection of two metal layers by means of a diffusion soldering process according to one exemplary embodiment of the present invention;

FIG. 3 shows a flow chart illustrating methods according to the invention for connecting two metal layers by means of a diffusion soldering process;

FIG. 4 shows a top view of a first embodiment according to the present invention having primary and secondary pads;

FIG. 5 is a graph illustrating the forces acting on pads of different diameters due to displacement from a given solder thickness; and

FIG. 6 shows a top view of a second embodiment according to the invention having primary and secondary pads.

### DESCRIPTION OF THE PREFERRED EMBODIMENTS

The invention will be described below in detail with reference to the drawings.

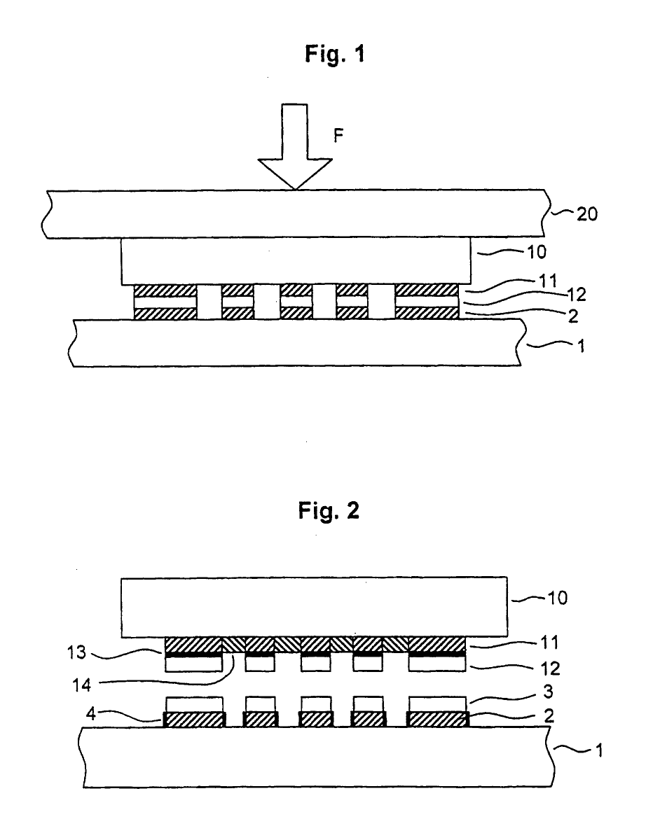

FIG. 2 shows a side view of a bottom wafer 1 and a top chip 10. The bottom wafer 1 can also be another chip and a plurality of top chips 10 may be placed on the bottom wafer 1. A metal layer 2 is arranged on the bottom wafer 1. Arranged on the metal layer 2 is a solder layer 3 which is patterned in the same way as the metal layer 2. Arranged on the top chip 10 is a metal layer 11 and another solder layer 12 is arranged on the metal layer 11. The solder layer 12 is patterned in the same way as the metal layer 11 and symmetric to the patterning of the solder layer 3 and the metal layer 2 of the bottom wafer 1. The patterns form pads which connect to structures in the bottom wafer 1 and in the top chip 10. The metal layers 2 and 11 are made from copper though the use of other metals is possible. The solder layers 3 and 12 are made of tin (Sn) or a silver-tin alloy (Ag—Sn) though other metals and alloys are possible. In contrast to FIG. 1, both metal layers 2 and 11 are plated with a solder layer 3 and 12. Further, no temperature resistant mat 20 is used to apply an external mechanical force on the top chip 10 during the soldering process.

The sidewalls of the metal layer 2 are covered with a non-wettable layer 4 as shown, which serves to prevent molten solder from attaching to the sidewalls of the metal layer 2. The non-wettable layer 4 is optional and may also be present on the sidewalls of the metal layer 11 of the top chip 10.

Further shown in FIG. 2 are diffusion barrier layers 13 which may be placed between the metal layer 10 and the solder layer 12 of the top chip 10. Again, this diffusion barrier layer 13 is optional and may also be placed between the metal layer 2 and the solder layer 3 of the bottom wafer 1. The diffusion barrier layer 13 can be made of nickel, tungsten or titanium and serves to slow the diffusion of the solder into the metal layers when heated. In this way, the time available for self-alignment of the top chip 10 on the bottom wafer 1 and for wetting of the solder layers 3 and 12 can be increased before the solidification of the diffusion soldering joint occurs.

Still further shown in FIG. 2 are leveling elements 14 which are placed between the pads of the metal layer 11. The leveling elements 14 are optional and can also be placed between the sidewalls of the patterns of the metal layer 2 of the bottom wafer 1. The purpose of the leveling elements 14 is to allow the use of low-precision placing tools without interlocking of the pads of the bottom wafer 1 with those of the top chip 10 to occur in case that the lateral positioning exceeds the gap between the pads. The leveling elements 14 only need to be placed between pads which are separated by a distance which is greater than the positioning accuracy. In order to avoid short circuits, the leveling elements 14 should be electrically insulating and non-wettable by the molten solder so that solder from the pads does not attach to them and bridge pads.

The diffusion soldering method according to the invention has several advantages. Due to the self-aligning the lateral displacements between the pads of the metal layers 2 and 11 vary less, so that stray capacitances have the same value and lower variations in the design parameters can be used. Further, the average lateral distance between the pads is increased which leads to higher electrical strength and better isolation of the pads. Another advantage is that top chips 10 having different thicknesses and even passive components can be soldered in the same diffusion soldering step. Due to the higher melting point of the intermetallic compounds formed, a sequence of diffusion soldering steps are also possible. Further, as no pressure needs to be applied to the top chip 10, the invention can be applied for diffusion soldering of thin chips which normally would bent or break due to the pressure applied. Finally, the solder evaporation rate of the solder is reduced and less leakage currents occur.

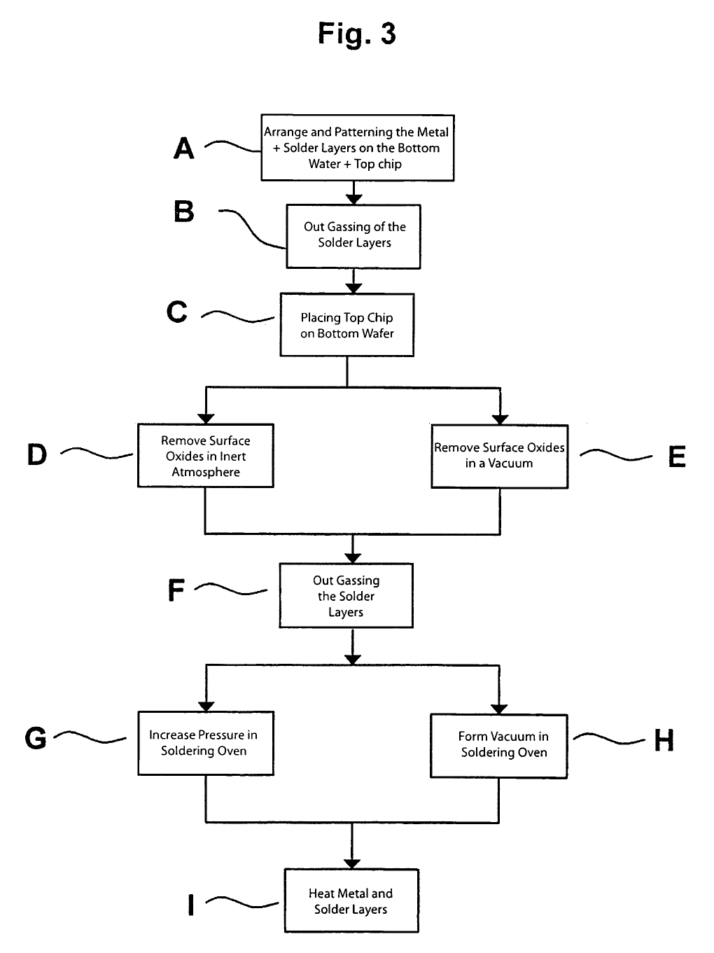

FIG. 3 shows a flow chart illustrating methods according to the invention for connecting two metal layers by means of a diffusion soldering process. For the purpose of illustration the metal layers are assumed to be on a bottom wafer 1 and a top chip 10, which act as carriers, as shown in FIG. 2. However, a person skilled in the art can apply or modify the method for use with other arrangements.

In step A the metal layers 2 and 11 and the solder layers 3 and 12 are arranged on the bottom wafer 1 and on the top chip 10 and are patterned. The layers may be applied by sputtering a seed layer which is then electroplated, while the patterning can be achieved by using lithography.

In step B the solder layers 3 and 12 are outgassed with a partial pressure of formic acid of 20 to 100 mbar, at a temperature which is just below the melting point of the solder, for a time period of two to three minutes. The outgassing can alternatively or additionally be performed in step F. If it is performed in step B, that is, before the top chip 10 is placed on the bottom wafer 1 in step C, the surfaces of the solder layers 3 and 12 are more accessible. The outgassing may be preformed in an oven which is more suitable for outgassing, for example in terms of the time required for heating, than the soldering oven. However, performing step B in the soldering oven has the advantage that there is no need to transport the bottom wafer 1 and the top chip 10 from an outgassing oven to a soldering oven.

In step C, the top chip 10 is placed on the bottom wafer 1. The top chip 10 may be fixed onto the bottom wafer 1 by means of an adhesive. The bottom wafer 1 is then placed into a soldering oven.

In the alternative steps D and E, surface oxides on the solder layers 3 and 12 are removed. This cleaning may be performed inside the soldering oven and is necessary so that the tin 3 of the bottom wafer 1 wets the tin 12 of the top chip 10.

For step D, an inert gas atmosphere is created by filling the soldering oven with nitrogen to dispel any oxygen present. The oven is heated to 170° C. and formic acid is added.

In the alternative step E, a vacuum is formed in the soldering oven, formic acid is added and then heated to 170° C.

Both step D and step E are performed at a temperature which is lower than the melting point of the solder, for example, at a temperature between 150° C. to 200° C. The temperature chosen is lower than the temperature for the outgassing in step B. The partial pressure of the formic acid is chosen to be between 20 and 100 mbar and the cleaning lasts between two to three minutes. The adhesive which is used to fix the top chip 10 on the bottom wafer 1 evaporates during the heating, so the top chip 10 can move freely enough for the self-alignment to occur.

Step F is identical to step B and is optional if step B has already been performed. If step B has not been preformed, then step F needs to be preformed to outgas the solder layers 3 and 12.

Before the actual soldering, one of the alternative steps G and H is performed.

In step G, the pressure in the soldering oven is increased by adding an inert gas together with a gaseous flux material, such as atomic hydrogen, molecular hydrogen, carbon monoxide, ammonia or formic acid (H, H₂, CO, NH₃, CH₂O₂). The increase in the pressure leads to an increase in the pressure in the molten solder so that cavities that are formed by the reduction in volume due to the formation of intermetallic compounds are compressed and filled with solder.

In the alternative step H, a vacuum with a partial pressure of formic acid of 20 to 100 mbar is formed inside the soldering oven. The reduced pressure causes cavities in the molten solder to expand and to burst. Step H may also be preformed without the formic acid. Both step G and step H aim at reducing the cavities inside the molten solder and removing any oxides present on the metal layers or the solder layers. Which step is used may depend on the volume of the solder in the joint.

In step I, the metal layers 2 and 11 and the solder layer 3 and 12 are heated to a temperature above the melting point of the solder, which is usually about 250 to 270° C. The molten solder layers 3 and 12 will wet each other, diffuse into the metal layers 2 and 11, react to form intermetallic compounds and then solidify.

The patterns formed in the metal layer 2 and the solder layer 3, as well as the metal layer 11 and solder layer 12, can be used to form pads for electrical connections. The pads would then connect contacts in the bottom wafer 1 or the top chip 10.

FIG. 4 shows a top view of a first embodiment in which the metal layers 2 and 11 as well as the solder layers 3 and 12 are patterned to form small primary pads 30 that are arranged between larger secondary pads 31. The primary pads 30 have diameters smaller than 30 μm and the secondary pads 31 have diameters greater than 30 μm. The diameter of the pads determines the surface tension and the hydrostatic pressure than can be supported by the molten solder. The molten solder between the smaller primary pads 30 has a greater tendency to form a sphere than the molten solder between the larger secondary pads 31. When the primary pads 30 and the secondary pads 31 are both in contact with their respective portions of molten solder, the primary pads 30 will therefore tend to push the metal layers 2 and 11 apart while the secondary pads 31 will try to keep them together. An equilibrium of these forces will occur when the sum of forces pushing the metal layers 2 and 11 apart is equal to the sum of forces pulling them together.

FIG. 5 illustrates the force required to change the thickness of molten solder between a pad depending on the diameter of the pad. Shown are the forces per mm² for pads with diameters of 10, 20, 50, 100, 200, 500, and 1000 μm and having a starting solder thickness of 3 μm. For small diameter pads a change in solder thickness requires only a small force while the same change in a larger diameter pad requires a significant force. The molten solder between the larger secondary pads 31 forms a spring with a higher stiffness than the solder between the smaller primary pads 30. As a consequence the solder thickness at equilibrium will be only slightly greater than 3 μm so that the secondary pads can be used to apply pressure to the molten solder between the primary pads 30. This pressure leads to a reduction in cavities as well as to an increase in wettability of the solder.

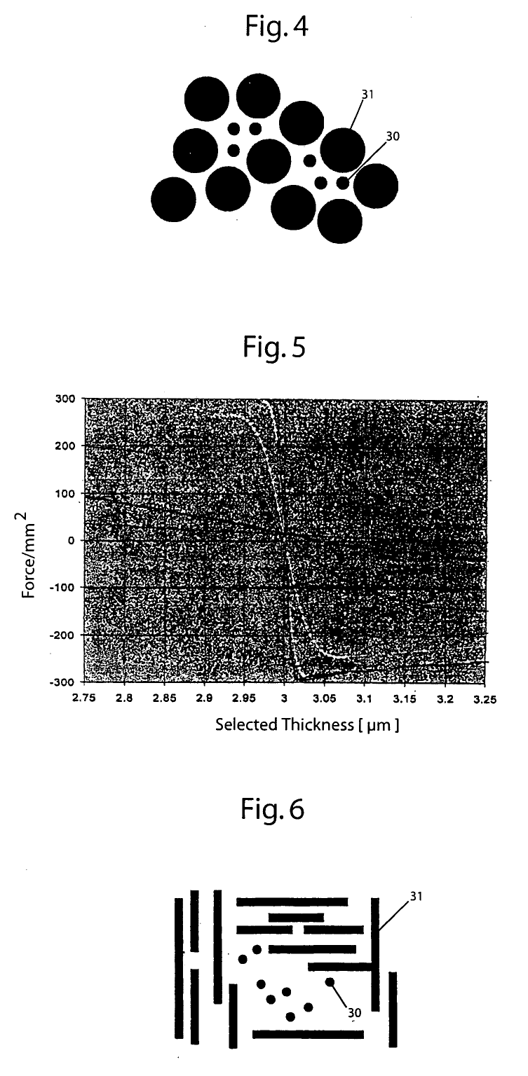

FIG. 6 shows a top view of a second embodiment in which the metal layers 2 and 11 as well as the solder layers 3 and 12 are patterned to form primary pads 30 and secondary pads 31. The secondary pads 31 are in the form of rectangles with primary pads 30 in the form of circles arranged between them. As the rectangles 31 are arranged orthogonally to each other, self-alignment can be achieved in two directions. Rectangular secondary pads 31 are especially useful when an additional wiring planes for connecting contacts in the bottom wafer 1 or the top chip 10 are required.

The embodiments shown in FIG. 4 and FIG. 6 can be modified so that the secondary pads 31 are placed between the primary pads 30. In each case the positioning and size of the primary pads 30 and secondary pads 31 are chosen in such a way that the hydrostatic forces acting on the metal layers 2 and 11 balance each other and align the surfaces of the metal layers 2 and 11 parallel to each other. As a result the thickness of the solder between the metal layers 2 and 11 will be uniform. If the distance between the primary pads 30 is greater that the positioning accuracy of the placement tool, it is possible that corresponding primary pads 30 on opposite solder layers 2 and 11 will not be in contact with each other. In this case the larger secondary pads 31 can be sized and placed in such a manner that at least some of the corresponding secondary pads 31 on opposite metal layers 2 and 11 are in contact with each other and can be used for self-alignment by means of the forces due to the surface tension in the molten solder. The metal layers 2 and 11 will then move into place so that the corresponding primary pads 30 will also be soldered together, even though they were at first displaced with respect to each other.

It will be appreciated that the present invention is directed to a method for connecting at least two metal layers by a diffusion soldering process that overcomes the deficiencies associated with conventional diffusion soldering processes, as described above. In particular and as mentioned above, no external force is required to be applied to the metal layers and improved self-alignment is achieved.

The self-alignment is caused by forces, which try to move the metals layers into such a position with respect to each other that the surface area of the molten solder is minimized. This allows the use of placing tools with lower precision and higher throughput.

Specifically, the forces due to the surface tension are increased by increasing the wettability of the molten solder. While the molten solder already is in contact with the metal layers, it is known that molten tin does not wet molten tin. As a result, no self-alignment forces are active when trying to diffusion solder two metal layers which are plated with a solder layer each. To achieve self-alignment during the soldering process the wettability of the molten solder has to be increased.

As a result, no external mechanical pressure is exerted on the metal layers during the diffusion soldering process. The metal layers are free to move laterally so that self-alignment is possible. Gravitational forces and atmospheric pressures are not considered to be external mechanical forces.

The solder in the solder layers is only heated once above the melting point of the solder. This is in contrast to the solder ball or flip-chip connection methods in which the solder is first heated to form solder balls and then heated again after the parts that are to be joined are placed into contact with each other. In the invention the solder is applied by sputtering and electroplating as heating it above the melting point would cause the solder to react with the metal layers to form intermetallic compounds.

The solder is heated after placing the solder layers in contact with each other and aligning them with respect to each other. The solder layers are first roughly aligned with respect to each other by a placing tool. The precise positioning is then achieved by the self-alignment due the forces of the surface tension in the molten solder.

In addition, the diffusion barrier layer is arranged between at least one of the metal layers and its respective solder layer. The diffusion barrier layer slows the diffusion of the solder into the metal layer and thus slows the reaction to form inter-metallic compounds. As a result, more time is available for self-alignment and wetting before the diffusion soldering joint solidifies.

While a number of suitable materials can be used to form the metal layers, exemplary materials include at least one of copper, silver, gold, and palladium. Along the same line, the solder layers can be formed of at least one of tin, silver, indium, gallium, bismuth, gold and copper.

Before performing the soldering, the solder layers are out-gassed at a partial pressure of formic acid in an inert gas atmosphere or in a vacuum. Experiments have shown that the out-gassing with formic acid is necessary for tin in the solder layers to be wettable by tin without having to apply an external mechanical pressure. The outgassing is typically performed at a temperature lower than the melting point of the solder and the partial pressure of the formic acid can be from 20 to 100 mbar, with the outgassing being performed for two to three minutes in one embodiment.

According to the present invention, during the diffusion soldering process, the metal layers and the solder layers are heated at such a rate that all of the solder of the solder layers is in a molten state for at least some time. If the heating rate is too slow, some of the solder will already have reacted with the metal layers to form intermetallic compounds and solidified so that no self-alignment is possible. The metal layers and the solder layers are heated at an increased atmospheric pressure to a temperature above the melting point of the solder. By heating the metal layers and the solder layers at an increased atmospheric pressure, the formation of cavities in the solder can be reduced. The pressure in the soldering oven prevents the expansion of the cavities by isotropically compressing the molten solder and pressing it into the cavities caused by the formation of the intermetallic compounds. In one aspect, the atmosphere contains gaseous flux material in an inert gas, with the gaseous flux material being at least one of atomic hydrogen, molecular hydrogen, carbon monoxide, ammonia and formic acid. The inert gas can be nitrogen or another oxygen-free atmosphere.

Alternatively, the metal layers and the solder layers are heated to a temperature above the melting point of the solder in a vacuum with a partial pressure of formic acid of 20 to 100 mbar. By heating the solder in a vacuum, the cavities in the molten solder will expand and burst. This will also work if the pressure in the soldering oven is significantly below 1 bar.

The metal layers can be arranged on carriers and patterned to form at least one pad. The solder layers are preferably patterned in the same shape as the respective metal layers. The solder layers and metal layers can thus be patterned together. Alternatively, the solder layers can be patterned in a shape different from the respective metal layers. The metal layers can form larger pads, such as those used for electromagnetic shielding, with the solder layer patterns forming smaller pads on the metal layer and being used for aligning the metal layers.

The solder layers can be patterned by means of solder resist. The solder resist is deposited on the metal layers and patterned. When plating the metal layers, the solder layers will only form on the part of the metal layers which are not covered by the solder resist. During the diffusion soldering process, the patterns of the solder resist instead of the patterns of the metal layers define the shape of the molten solder and determines the forces due to surface tension in the molten solder. The patterning of the solder resist on metal layers facing each other is symmetrical with respect to each other. For example, a circle formed in the solder resist on one metal layer has opposite to it in the same position and with the same size a circle formed in the solder resist on the opposing metal layer.

In another aspect of the present invention, the side walls of the at least one pad are covered with a layer that is not wettable by the molten solder. The non-wettable layer causes the molten solder to be restrained to the top surface of the metal layer thus avoiding bridging between pads. The pads of metal layers that are facing each other are structured symmetrically with respect to each other. Symmetric pads increase the self-alignment forces and provide for more accurate alignment. Also, the solder does not need to spread to wet the opposite metal layer.

The pads can be in the form of primary pads and secondary pads, wherein the secondary pads are larger in area than the primary pads and at least one primary pad is arranged between at least two the secondary pads. Alternatively, at least one secondary pad is arranged between at least two primary pads. After the wetting of the molten solder, hydrostatic forces act on the metal layers. The hydrostatic forces depend on the area of the pads, so that different sizes together with suitable positioning of the pads can be used to improve self-alignment and wettability of the solder. The primary pads can have diameters smaller than 30 μm and the secondary pads can have diameters greater than 30 μm.

During the diffusion soldering process, the hydrostatic pressure in the secondary pads is used to apply pressure to the molten solder between the primary pads. Due to the larger effective curvature in the solder between the secondary pads, the hydrostatic pressure in the larger secondary pads at equilibrium will be lower than the hydrostatic pressure in the smaller primary pads. At the same time, the solder between the larger secondary pads exhibits a greater stiffness than the solder between the smaller primary pads. As a result, the secondary pads can be used to apply pressure to the molten solder between these primary pads.

The secondary pads which have primary pads arranged between them, are arranged in such a manner that the sum of the hydro-static forces in the secondary pads on each side to the primary pads is equal, in order to produce the same pressure in each primary pad.

Similarly, the secondary pads which are arranged between primary pads, are arranged in such a manner that the sum of the hydrostatic forces in the primary pads to each side of the secondary pads is equal. This pressure is used to improve the wettability of the molten solder between the primary pads.

According to one exemplary embodiment, the carriers are in the form of wafers and substrates of electronic components. Electrical contacts in the wafer and substrates are connected to the metal layers so that the invention can be used for joining chips and electronic components by means of diffusion soldering.

The primary pads are used for electrical connections. While the self-alignment of the metal layers can be used for accurate positioning of a mechanical connection, the primary pads are used of advantage to electrically connect wafers, electronic components, chips and so on with each other. The secondary pads are used for at least one of a mechanical connection, stress relief of the primary contacts, heat dissipation, electromagnetic shielding, a wiring plane and an alignment mark. In addition to aiding the self-alignment and the wetting of the solder, the secondary pads can also fulfill the above-mentioned functions.

In another aspect, leveling elements are placed between at least two pads of at least one metal layer. The leveling elements have the same thickness as the metal layer. The leveling elements are electrically insulating and non-wettable by the solder.

It will be apparent to those skilled in the art that various modifications and variations can be made to the present invention without departing from the scope or the spirit of the invention. In view of the foregoing, it is intended that the present invention covers modifications and variations of this invention provided they fall within the scope of the following claims and their equivalents.

What is claimed is:

1. A method for connecting at least two metal layers by means of a diffusion soldering process comprises the step of:
plating each of the metal layers that is to be connected with a respective solder layer prior to performing the diffusion soldering process.

2. The method according to claim 1, wherein the metal layers are self-aligned with respect to each other during the diffusion soldering process by means of forces due to surface tension in the molten solder joining the metal layers.

3. The method according to claim 2, wherein
the forces due to the surface tension are increased by increasing the wettability of the molten solder.

4. The method according to claim 3, wherein the step of performing the diffusion soldering process comprises performing the diffuse soldering process free of any external mechanical pressure being exerted on the metal layers during the process.

5. The method according to claim 4, comprising the step of:
heating the solder in the solder layers only once above the melting point of the solder.

6. The method according to claim 5, comprising the step of:
heating the solder after placing the solder layers in contact with each other and aligning them with respect to each other.

7. The method according to claim 7, comprising the step of:
arranging a diffusion barrier layer between at least one of the metal layers and its respective solder layer.

8. The method according to claim 1, wherein the metal layers comprise at least one of copper, silver, gold and palladium.

9. The method according to claim 1, wherein the solder layers comprise at least one of tin, silver, indium, gallium, bismuth, gold and copper.

10. The method according to claim 1, comprising the step of:
outgassing the solder layers before soldering at a partial pressure of formic acid in one of an inert gas atmosphere and in a vacuum.

11. The method according to claim 10, wherein the outgassing step comprises:
performing the outgassing at a temperature lower than the melting point of the solder.

12. The method according to claim 11, wherein the partial pressure of the formic acid is 20 to 100 mbar.

13. The method according to claim 8, wherein the outgassing step comprises:
performing the outgassing for two to three minutes.

14. The method according to claim 10, comprising the step of:
heating the metal layers and the solder layers, during the diffusion soldering process, at such a rate that all of the solder of the solder layers is in a molten state for at least some time.

15. The method according to claim 14, wherein the heating step comprises:
heating the metal layers and the solder layers at an increased atmospheric pressure to a temperature above the melting point of the solder.

16. The method according to claim 15, wherein the atmosphere contains gaseous flux material in an inert gas.

17. The method according to claim 16, wherein the gaseous flux material is at least one of atomic hydrogen, molecular hydrogen, carbon monoxide, ammonia and formic acid.

18. The method according to claim 14, wherein the heating step comprises:
heating the metal layers and the solder layers to a temperature above the melting point of the solder in a vacuum with a partial pressure of formic acid of 20 to 100 mbar.

19. The method according to claim 1, comprising the step of:
arranging the metal layers on carriers and patterned to form at least one pad.

20. The method according to claim 19, further including the step of:
patterning the solder layers in the same shape as the respective metal layers.

21. The method according to claim 19, further including the step of:
patterning the solder layers in a shape different from the respective metal layers.

22. The method according to claim 21, wherein the step of patterning the solder layers comprises the step of:
patterning the solder layers by means of a solder resist.

23. The method according to claim 22, wherein the step of patterning the solder layers including the step of:
patterning of the solder resist on metal layers facing each such that the metal layers are symmetrical with respect to each other.

24. The method according to claim 19, comprising the step of:
covering the side walls of the at least one pad with a layer that is not wettable by the molten solder.

25. The method according to claim 19, wherein the pads of metal layers that are facing each other are structured symmetrically with respect to each other.

26. The method according to claim 25, wherein the pads comprise primary pads and secondary pads, wherein
the secondary pads are larger in area than the primary pads, and at least one primary pad is arranged between at least two secondary pads.

27. The method according to claim 26, comprising the step of:
arranging the secondary pads in such a manner that the sum of the hydrostatic forces in the secondary pads to each side of the primary pads is equal.

28. The method according to claim 25, wherein the pads comprise primary pads and secondary pads, wherein the secondary pads are larger in area than the primary pads, and at least one secondary pad is arranged between at least two primary pads.

29. The method according to claim 28, comprising the step of:
arranging the secondary pads in such a manner that the sum of the hydrostatic forces in the primary pads to each side of the secondary pads is equal.

30. The method according to claim 26, wherein the primary pads have diameters smaller than 30 μm, and the secondary pads have diameters greater than 30 μm.

31. The method according to claim 26, wherein during the diffusion soldering process, the hydrostatic pressure in the secondary pads is used to apply pressure to the molten solder between the primary pads.

32. The method according to claim 19, wherein the carriers comprise wafers and substrates of electronic components.

33. A mechanical connection for connecting at least two metal layers by means of a diffusion soldering process, wherein each of the metal layers that is to be connected is plated with a respective solder layer.

34. The connection according to claim 33, wherein a diffusion barrier layer is arranged between at least one of the metal layers and its respective solder layer.

35. The connection according to claim 34, wherein the metal layers comprise at least one of copper, silver, gold and palladium.

36. The connection according to claim 35, wherein the solder layers comprise at least one of tin, silver, indium, gallium, bismuth, gold and copper.

37. The connection according to claim 33, wherein the metal layers are arranged on carriers and patterned to form at least one pad.

38. The connection according to claim 37, wherein at least one pad is selected from the group consisting of: a seal ring, a stress relief of the primary contacts, a heat sink, an electromagnetic shield, a wiring plane, and an alignment mark.

39. The connection according to claim 37, wherein the side walls of the at least one pad are covered with a layer that is not wettable by the molten solder.

40. The connection according to claim 37, wherein the pads of metal layers that are facing each other are structured symmetrically with respect to each other.

41. The connection according to claim 37, wherein leveling elements are placed between at least two pads of at least one metal layer, wherein the leveling elements have the same thickness as the metal layer and fill the gap between the two pads.

42. The connection according to claim 41, wherein the leveling elements are electrically insulating and non-wettable by the solder.

43. The connection according to claim 37, wherein the pads comprise primary pads and secondary pads, wherein the secondary pads are larger in area than the primary pads, and at least one primary pad is arranged between at least two secondary pads.

44. The connection according to claim 37, wherein the pads comprise primary pads and secondary pads, wherein the secondary pads are larger in area than the primary pads, and at least one secondary pad is arranged between at least two primary pads.

45. The connection according to claim 43, wherein the primary pads have diameters smaller than 30 μm, and the secondary pads have diameters greater than 30 μm.

46. The connection according to claim 37, wherein the carriers comprise wafers and substrates of electronic components.

47. The connection according to claim 46, wherein the primary pads are electrical connections to electrical elements in the wafers and substrates.

48. A layered structure to be exposed to a diffusion soldering process to form a joined structure comprising:
a first substrate having a first metal layer formed thereon according to a first pattern to define a plurality of first pads;
a second substrate having a second metal layer formed thereon according to a second pattern to define a plurality of second pads;
a first solder layer plated on the first metal layer according to the first pattern;
a second solder layer plated on the second metal layer according to the second pattern; and
means associated with sidewalls of at least one of the first and second metal layers for preventing molten solder from attaching to the sidewalls;
wherein the first and second substrates are arranged by placing the first and second solder layers in an abutting relationship for joining the first and second substrates together by the diffusion soldering process.

49. The layered structure of claim 48, wherein the means comprises a non-wettable layer that is disposed on the sidewalls.

50. The layered structure of claim 48, further comprising:
a plurality of leveling elements disposed between at least one of the first pads and the second pads, the leveling elements being formed of an electrically insulating material that is non-wettable by molten solder for preventing solder from the pads from attaching to the leveling elements and thereby bridge the pads.
